(19) United States
(12) Patent Application Publication
(10) Pub. No.: US 2003/0172017 A1
(43) Pub. Date: Sep. 11, 2003

(54) High performance multi-dimensional risk engines for enterprise wide market risk management

(76) Inventors: Vincent Feingold, Stanhope, NJ (US); Julie Shapiro, Brooklyn, NY (US); Donald Conte, Hillsdale, NJ (US); Katrina Kalish, Brooklyn, NY (US)

Correspondence Address: DICKSTEIN SHAPIRO MORIN & OSHINSKY LLP, Michael J. Scheer, 41st Floor, 1177 Avenue of the Americas, New York, NY, 10036-2714, US

(21) Appl. No.: 10/384,721

(22) Filed: Mar. 11, 2003

Related U.S. Application Data
(60) Provisional application No. 60/363,641, filed on Mar. 11, 2002.

(51) Int. Cl. G06F 17/60

(52) U.S. Cl. 705/35

(57) ABSTRACT

A system and method for performing Value at Risk (VaR) analysis at a large volume scale. The system employs two basic types of elements in its architecture: controllers and brokers. Controllers are engines that perform actual processing of data, while brokers manage the access to and from the data resources. Controllers of the present invention have three main components, an input queue, a manager and workers. The controllers retrieve units of work from the incoming queue, process the units, and place the result onto an outgoing queue. The outgoing queue of one controller is shared with the next element in the processing chain. Brokers are responsible for maintaining pool of common resources and providing access to those resources to a requestor (i.e., a controller). In the preferred embodiment, the resource is a data source, such as a database containing market pricing data. The broker accesses the data source though an adapter. In addition to accessing data from the data source a broker maintains a cache of cacheable elements. The system of the present invention further includes a query subsystem for generating reports relating the risk positions.

### CROSS REFERENCE TO RELATED APPLICATIONS

This application claims priority to U.S. Provisional Application No. 60/363,641, filed on Mar. 11, 2002, the entirety of which is incorporated herein by reference.

### FIELD OF THE INVENTION

The present invention generally relates to systems for performing risk management analysis, and more particularly to a system with a scalable architecture.

### BACKGROUND OF THE INVENTION

Large financial institutions typically have a large portfolio of investment positions at any given point in time. Value-at-Risk (VaR) has become the standard manner by which the risk associated with the portfolio is measured within these large financial institutions. VaR was first developed as a measure of market risk to describe the potential loss incurred by unfavorable market conditions.

As used in the present discussion, the term “risk” is defined as the uncertainty of profits or a possibility of losses in a portfolio of financial securities. Risk of a portfolio thus encompasses all possible values of losses (or results of underperformance compared to a benchmark) over a fixed period of time. Risk is therefore mathematically described as a random variable. As described above, the generally accepted quantitative measure of risk for assessment and comparison purposes is VaR. VaR is a pre-defined, usually 99%, quantile of the probability distribution of this random variable.

The market risk associated with a portfolio can be separated into “continuous market risk”, stemming from continuous fluctuations of market prices of instruments in the portfolio, and “event and default risk”, which is due to possible abrupt jumps in the instruments' prices caused by events specific to individual issuers (e.g., events affecting actual or perceived creditworthiness or future profitability of the issuers). For debt instruments, possible credit events typically include changes of externally assigned credit ratings or default (insolvency) of the instrument's issuer. The internal model specific risk add-on is “event risk” for individual equities and their derivatives. The one-year history of the broad market is by regulatory fiat a sufficient measure of the historical risk of the broad market. Thus the event risk add-on for equities must be some measure of historical events spanning “a full business cycle” which are idiosyncratic to an individual equity and not captured in the one-year VaR. An equity event is defined as a jump discontinuity in price relative to the broad market, observed during an entire business cycle, which is a larger percent price change than any price changes that were observed over the previous year and thus already incorporated into the VaR estimate

Broadly, a portfolio contains linear and non-linear positions. For linear holdings (e.g., direct ownership stock) the VaR of the market risk can be calculated analytically. For non-linear holdings (e.g., options and derivatives) a model incorporating historical daily rate changes is typically applied to the current portfolio, in order to generate a distribution for the value, and therefore the risk associated with the future of the portfolio.

The output of a risk system is a database that is generated in conformance with the above described models. The database is re-generated at least on a daily basis, and is typically re-generated, at least in part, on an intra-day basis to accommodate intra-day changes in the positions held by the financial institutions. The database is queried by the risk managers of the financial institution in order to generate risk reports. Generally these reports are generated for two purposes—to comply with regulatory requirements and to manage the risk associated with the portfolio. Some databases of prior art risk management systems are structured in the form of a multidimensional cube of cells (nodes). The cells represent the various positions contained in the portfolio. In the prior art risk management systems where a multidimensional model is used, the cell contains only a scalar measure representing one particular measure of the position.. For more complex risk engines of the prior art, this cube of cells has no more than 10 different dimensions such as the currency of the position, the market in which the position exists and so on.

The nature of the cube is such that that reports can be easily generated that satisfy the needs of the particular user. For example, upper management requires reports that can convey executive level information, e.g., does the portfolio satisfy federal regulations for capital requirements. Alternatively, the reporting from the cube can be drilled down to a trading desk level such that trader will know exactly the predicted short term risk associated with the portfolio in which she is trading.

FIG. 1 illustrates a risk engine of the prior art. As previously described, the positions of the portfolio must be evaluated at least on a daily basis as the market for the investments is ever changing. Element 100 represent the datastreams that supply the risk engines with the raw data relative to the positions of the portfolio. The raw data to be processed was directed to one of a plurality of processors (pipes) 102-108 to be valued. For example, positions that were comprised of U.S. equities would have been directed to processing system 102, foreign bonds would have been processed in pipe 104, options and derivatives would have been processed by system 106, and so on. The position data, once valued by the processing pipes 102-108, was used to populate the above described cube in database 110.

In the prior art system, there was essentially no sharing of data and no sharing of resources. Each system 102-108 had its own set of resources (e.g., processors) and exclusively operated on a particular type of data (e.g., U.S. equities). This architecture, although adequate for certain size financial institutions is unable to keep up with increasing volumes of financial data for growing financial institutions. For example, if there is a merger of two mid sized financial institutions into one larger institution, the risk systems of either of the institutions would not be able to accommodate the risk management processing of the other institution. This typically led to disparate risk management systems within a financial institution, with potentially arbitrary assignment of which data was to be processed by which system.

The only way that the systems of either institution would be able to handle the increased volume would be to purchase more, larger, faster and increasingly expensive processors and networks. But even this solution has its limits as the architecture of the above described prior art risk management systems can only be scaled up so much. One significant problem discovered by the present inventors is that the architecture of the prior art systems leads to uneven workload distribution that in turn leads to unacceptable delays in valuation and reductions in the system's throughput. The inventors of the current system performed benchmarking test of the prior art systems on increasingly bigger machines and networks and found that there was a clear limit to the extent at which the system would no longer scale.

The inventors found that the prior art system was completely incapable of valuing a portfolio of one million positions for the simultaneous processing of 1 day VAR, 10 Day VAR, corporate stress tests and specific issuer risk processing in a timely manner.

It is accordingly an object of the present invention to provide a scalable risk management processing system that solves the above described problems of the prior art

### SUMMARY OF THE INVENTION

The present invention is a system and method for performing Value at Risk (VaR) analysis at a large volume scale using multidimensional risk representation.

The database of the risk management system of the present invention preferably contains more than 10 dimensions (e.g., 23) which makes it much more flexible than the databases of the prior art. In the present system, the elements in the cube are not mere numbers, but are objects that can generate different VaR vectors, such as a number of positions (e.g., 256) for a ten day holding period, a one day holding period or any reasonable period specified by the user. These cell entries are distributions of multiple random variables. The system is implemented as a set of collaborating sub-components, that uses both partitioning and pipeline parallelism, and is heavily multi-threaded. The system employs two basic types of elements in its architecture: controllers and brokers. Controllers are engines that perform actual processing of data, while brokers manage the access to and from the data resources.

Controllers of the present invention have three main components, an input queue, a manager and workers. The controllers retrieve units of work from the incoming queue, process the units, and place the result onto an outgoing queue. The outgoing queue of one controller is shared with the next element in the processing chain. Brokers are responsible for maintaining pool of common resources and providing access to those resources to a requestor (i.e., a controller). In the preferred embodiment, the resource is a data source, such as a database containing market pricing data. The broker accesses the data source though an adapter. In addition to accessing data from the data source a broker maintains a cache of cacheable elements.

Using the controller and broker structures as described above, the risk engine of the present invention is scalable to virtually any size. As the processing load increases additional, workers, can be added to increase the processing power of the system.

### BRIEF DESCRIPTION OF THE DRAWINGS

For the purposes of illustrating the present invention, there is shown in the drawings a form which is presently preferred, it being understood however, that the invention is not limited to the precise form shown by the drawing in which:

FIG. 1 illustrates the a prior art system for performing risk valuation;

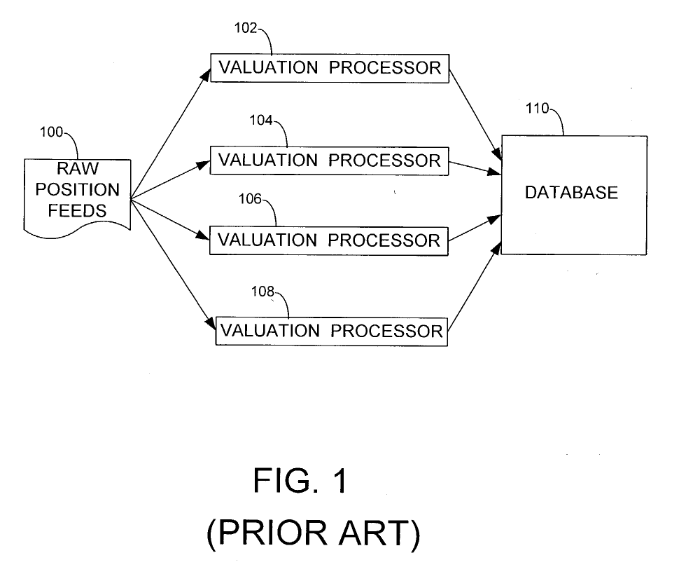

FIG. 2 depicts the risk engine based system of the present invention;

FIG. 3 shows a more detailed illustration of the system of the present invention;

FIG. 4 illustrates a controller pattern of the present invention;

FIG. 5 depicts a broker pattern of the present invention;

FIG. 6 illustrates the query subsystem of the present invention; and

FIG. 7 depicts a hierarchy for a dimension of a multidimensional cube.

### DETAILED DESCRIPTION OF THE INVENTION

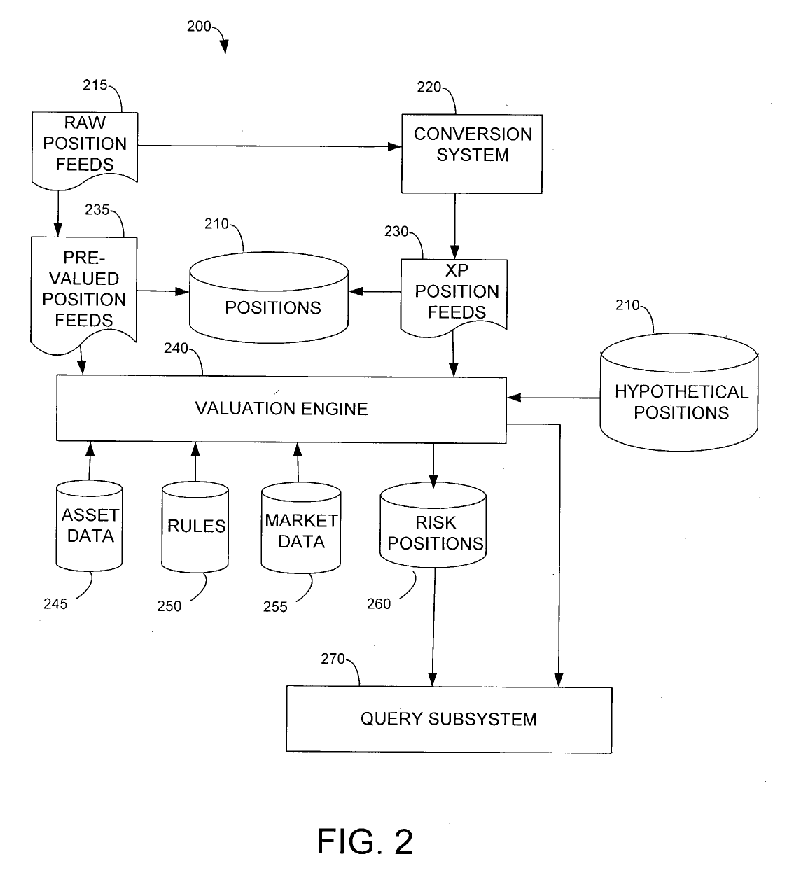

The system 200 of the present invention is illustrated in FIG. 2. The system 200 is capable of processing at least 900,000 risk positions on a daily basis and is scalable to accommodate volume increases in excess of a million positions. In a preferred embodiment, system 200 is hosted on a SUN E10000 Server.

System 200 is able to run simultaneous calculations based on various methodologies. This means that system 200 allows the risk managers to value, within the same run, positions according to historical simulation methodology with one day holding period and ten days holding period, using absolute and proportional shift types, for VaR, Market Stress, and Specific Issuer Risk. System 200 additionally provides improved transparency, meaning that users are able to see what prices and shock factors were used for a valuation of any particular position.

As further described below, system 200 is capable of accommodating not only overnight position feeds, but also intra-day feeds, and hypothetical positions. System 200 provides a foundation for valuing hypothetical positions using real prices, real positions using hypothetical prices, and hypothetical positions using hypothetical prices. System 200 also provides the ability of risk managers to create portfolios that include both real and hypothetical positions in order to evaluate how additional trades, a change in prices, or a change in shock factors may affect the risk profile of the portfolios under analysis.

Database 210 contains the data representing the positions constituting the portfolio of the financial institution. The portfolio typically contains a large number of positions (e.g., several hundred thousand). Each position contains at least identification information; booking related information; non-statistical measures, such as quantity or net open position; asset related information such as product type, CUSIP or ticker, credit rating; and issuer related information such as ISIN, name, type. Instruments representing different positions may be associated with the same issuer. Typically, the portfolio of an entire financial institution is divided into subportfolios. The organization of the subportfolios is such that each subportfolio preferably contains only positions which share a common issuer or are traded by the same desk, etc.

A raw feed 215 of changes in the financial institution's positions is processed on at least on a daily basis. The bulk of raw feed 215 typically comes into system 200 during the night as the various systems supporting the various divisions of the institution report the changes in the company's positions that occurred during the day (e.g., sold 10,000 shares of XYX stock and bought $1,000,000 worth of bonds issued by company ABC). Furthermore, as positions change throughout the day, it may be desirable or even necessary to update the position in database 210 to reflect these changes. Intraday updates will also be expected if the system 200 I operated in the in the United States as foreign subsidiaries of the financial institution report their trading activities through out the day.

As further described below, since the data in raw feeds 215 originate from a variety of different sources, the data must be converted into a common format before the position data in database 210 can be updated. This conversion is performed by element 220 illustrated in FIG. 2. System 200 can either value the position itself, or process positions that have valued externally according to scenarios specified by system 200. Positions that need to valued internally by the system arrive in Extended Position Format (XP) Files. The positions are converted in conversion system 200 and fed into database 210 through element 230. Positions that were valued externally (although in accordance with scenarios specified by system 200) arrive through Prevalued Position Feeds element 235. Each of elements 230 and 230 perform an enhancement function such as filling in missing data, cleaning the data, formatting and resolving conflicting data.

Element 240 broadly represents the Valuation/Risk Engine of the present invention. Although denoted as a single engine, Valuation/Risk Engine 240, as further described below in greater detail, is actually comprised of several engines, calculators, adapters, information brokers and other processing components. One of the important functions of the Valuation/Risk Engine 240 of the present invention is calculating hypothetical market values. Valuation/Risk Engine 240 is implemented as a set of collaborating sub-components, that uses both partitioning and pipeline parallelism, and is heavily multi-threaded. As described above, Valuation/Risk Engine 240 is preferably implement on an enterprise class MPP server (such as an E10000 server). The partition and pipeline parallelism design of the present architecture makes the most efficient use the power of this server.

The valuation processing function of Valuation/Risk Engine 240 consists of valuing the positions from the submitted data feed 215 and saving the valued positions in the database 210 for sub-sequent retrieval, analysis and querying. More specifically, the process consists of: retrieving positions from the input stream 215; obtaining proper calculator for the position depending on the instrument of the position; retrieving necessary prices, performing valuation, and storing the position in the database 210 for sub-sequent retrieval. Position database 210 contains position information as it was sent by the feeder systems 215. As described above, some of these positions are pre-valued (inputted through element 235) and some are not valued (input through element 230). Risk position database (database 260) contains results of valuation and classification for each position. This database is a physical storage for a compressed virtual multidimensional cube, typically stored in the form of an interrelated set of tables.

Coupled to the Valuation/Risk Engine 240 are several databases that are employed in the valuation and risk determination processes. Asset Data database 245 contains data related to the assets represented in the positions. For example, for equities, the asset may be identified by their industry standard codes such as ISIN (for International Securities Identification Number) or CUSIP (for Committee on Uniform Securities Identification Procedures). Asset database 245 contains static information about an asset, such as a coupon rate for fixed coupon bonds, or a reset schedule for floating coupon bonds, expiration and strike data for options, fixed coupon information, spread data and so on. Rules Database 250 contains various rules that govern the processing of data in Valuation?/Risk Engine 240. In a preferred embodiment, these are business rules stored in metadata format in the database 250. Rules database 250 contains rules that, for each position, determine what valuation model to use and how to map input parameters of the model to the attributes of the position. As further described below, Rules database 250 describes the libraries in system 200 that are required to value each of the positions. Market Data database 260 contains market data related to the assets represented in the positions. For example, the price of a stock. This market data is typically obtained from commercially available data streams of real time exchange market data such as BLOOMBERG™ and REUTERS™. As opposed to Asset database 245 that contains static data regarding assets, Market Data database 255 contains dynamic information about assets, such as prices, durations, deltas, gammas, Vegas, rates, yields, etc.

As further described below, Risk Position database 260 contains the calculated risk positions. As previously discussed, the preferred form of the risk positions is a multidimensional cube of cells (nodes). Risk Position database is a compressed form of this cube that is subsequently expanded by the Query subsystem 270 when users are performing actual queries of the system 200. Hypothetical database 265 contains hypothetical positions that user wish to test. For example, what would happen to my risk position if I sold 10,000 shares of XYZ stock from my portfolio. Finally, a Query Subsystem 270 is coupled to the Risk Position database 260. This Query Subsystem 270 is employed by various users within the financial institution (risk managers, traders . . .) in order to access the risk positions in a comprehensible and meaningful manner. Although illustrated in the figure as a database, element 265 can be configured as an interface that accepts hypothetical positions that are not necessarily stored in a formal database, e.g., real time generated hypothetical position.

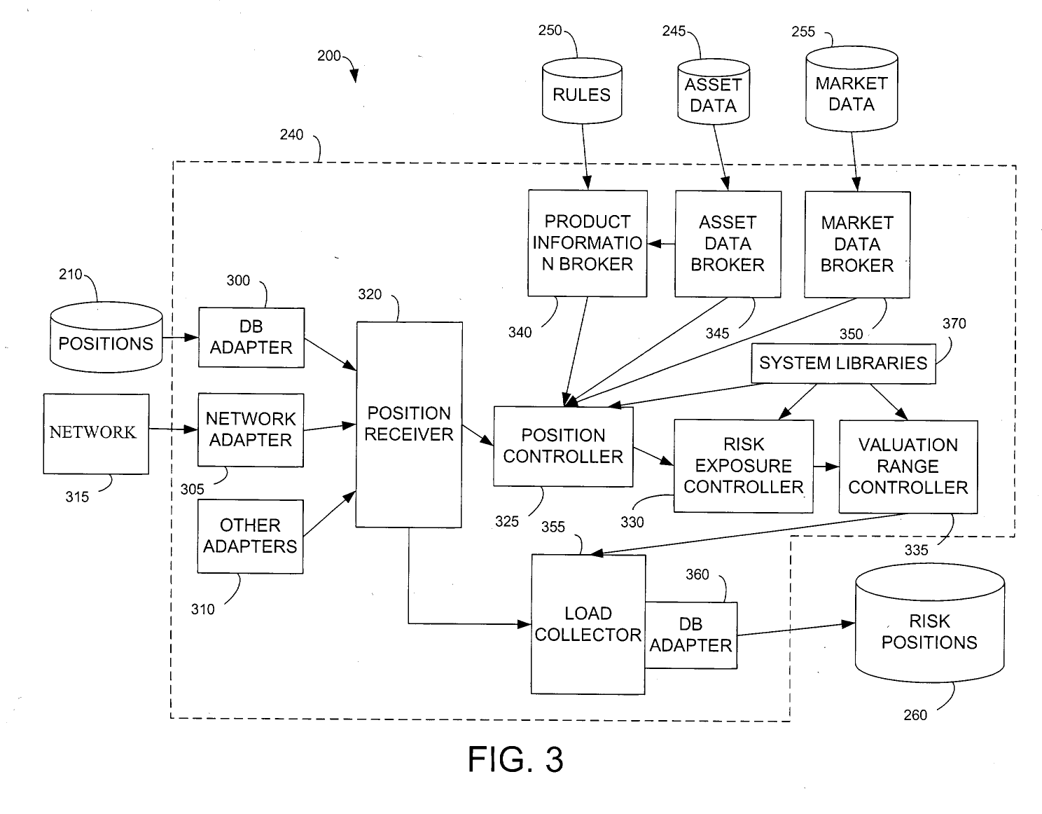

FIG. 3 illustrates the Valuation/Risk Engine 240 of the present invention in greater detail. Illustrated in FIG. 3 are three input adapters to Engine 240: a database stream adapter 300; a file stream or network adapter 305; and other types of adapters 310. The other type of adapters could include an MQ Series stream adapter for interfacing with the popular messaging MQ Series servers from IBM Corporation or a web services adapter. Database adapter 300 is coupled to Position database 210. Network adapter 305 is coupled to network 315. Other adapters 310 are coupled to other position data sources, such as an MQ series device as described above. Each of the three media stream adapters 300, 305, 310 is preferably capable of reading at least following formats: FIX messages; XML messages; and EDI messages. FIX is short for the Financial Information Exchange protocol, a vendor-neutral standardized message format for describing real time security transactions. FIX is a public-domain specification owned and maintained by FIX Protocol, Ltd. The protocol supports the following electronic conversations between brokers and other financial institutions: equity order submissions, cancellations and replacements; equity execution reporting; equity order statusing; equity trade allocation; Indication of interest communication; Completed trade advertisements; and directed e-mail and news messaging. XML is short for Extensible Markup Language, a specification designed especially for web documents. XML allows for customized tags that enable the definition, transmission, validation, and interpretation of data between applications and between organizations. EDI is an acronym for the Electronic Data Interchange standard. EDI is a common standard for the transfer of data between different companies using networks, such as the Internet. As more and more companies get connected to the Internet, EDI is becoming increasingly important as an easy mechanism for companies to buy, sell, and trade information. ANSI has approved a set of EDI standards known as the X12 standards.

The function of the adapters 300, 305 and 310 is to control the input stream from the source to which it is attached. For example, the Database adapter 300 is coupled to the position database 210, while the adapter 305 is coupled to a network 315. The adapters 300,305 and 310 efficiently retrieve incoming messages, construct a message object and place it on an outgoing queue that is shared between the adapter 300, 305 and 310 and the next element in the processing chain, the Position Receiver 320.

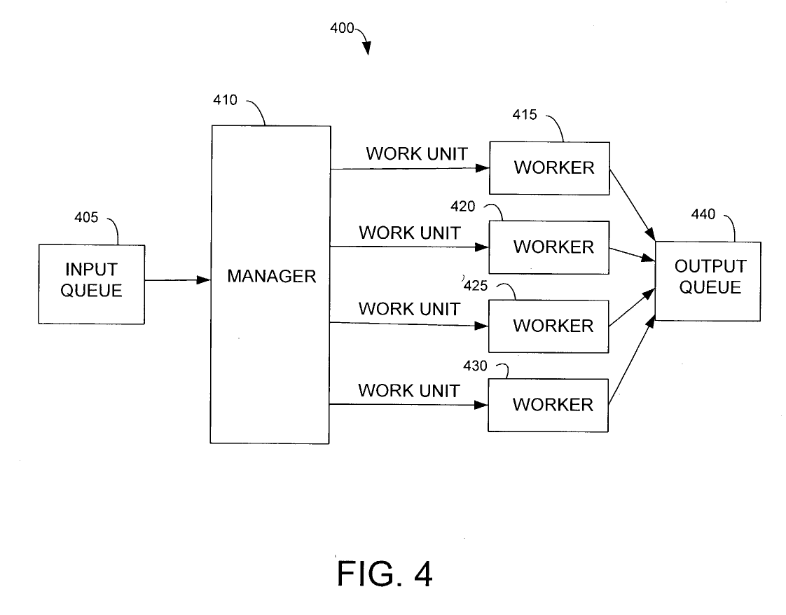

There are two types of structures that are basic to the architecture of the system 200 of the present invention, controllers and brokers. Controllers are engines that perform actual processing of data, while brokers manage the access to and from the data resources. The structure of a pattern of a typical controller is illustrated in FIG. 4. A pattern is a generic solution to a common problem. In an object oriented system, a pattern is realized as group of classes that serve as a foundation for specific customization.

The controller 400 as shown in FIG. 4 has four main components, an input queue 405, a manager 410, workers 415-430 and an output queue 440. The function of a controller 400 is to retrieve unit of work from the incoming queue 405, process the unit, and place the result onto an outgoing queue 440. In the typical configuration the output queue 440 is shared between the controller 400 and the next element in the processing chain. That is to say, the output queue 440 of a first controller 400 is the input queue 405 of the next controller 400 in the chain. A particular unit of work is actually processed by one of the workers 415-430 in the context of separate threads. Each worker 415-430 executes on its own thread and has its own resources.

One of the advantages of the architecture of the controller 400 (and in turn the entire system 200) is that the number of workers available to any given controller 400 is a tunable parameter that is auto configurable and has an adjustable fanout factor. The particular controller 400 illustrated in FIG. 4 is illustrated as having pool of 4 workers 415-430, but in a preferred embodiment, this configuration can be expanded up to 40 workers. In operation, when a controller 400 retrieves a work unit from the input queue 405, it finds a free worker 415-430, and assigns the unit of work to the selected worker 415-430. If more workers are required to perform the work units being processed by a particular controller 400, more workers are configured to the controller 400. Each controller 400 contains two configurable parameters with respect to workers—a minimum number of workers and a maximum number of workers. In the preferred embodiment, a controller 400 never has fewer than the minimum number of workers, even if its input queue 405 is empty. A controller 400 preferably never has more workers than the configured maximum number of workers, even if its input queue 405 is full. If the current number of workers is less than maximum number of workers, and there are elements (work units) on the input queue that are ready for processing, a controller 400 automatically creates another instance of worker and assigns the element to the new worker. The parameters such as the minimum and maximum number of workers for a controller 400 are specified in a configuration file for the system 200.

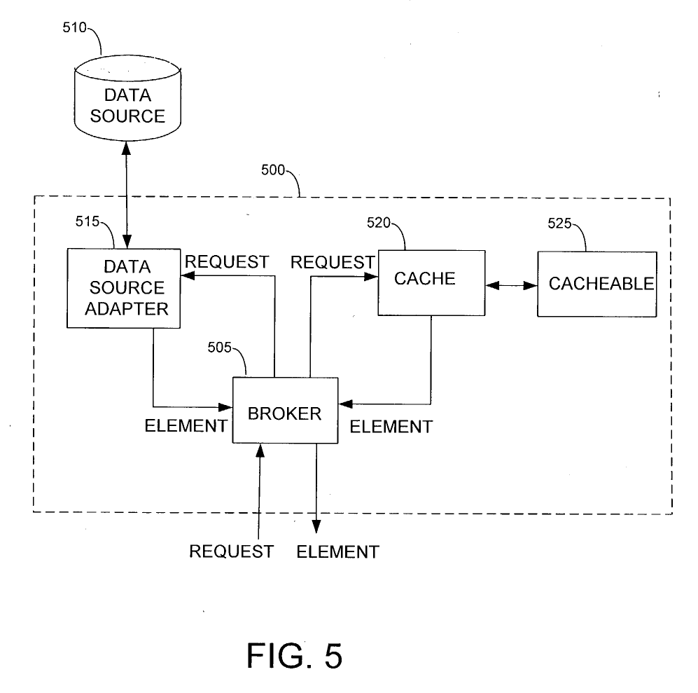

As described above, the other basic structure of the architecture of the present invention is a broker. A broker pattern 500 is illustrated in FIG. 5. A broker 505 is responsible for maintaining pool of common resources and providing access to those resources to a requestor. In the preferred embodiment, the resource is a data source 510, such as the Market Data database 255 illustrated in FIG. 3. The broker accesses the data source 510 though an adapter 515.

In addition to accessing data from the data source 510, broker 505 maintains a cache 520 of cacheable elements 525. In operation, a controller 400 (FIG. 4) makes a data request upon a broker 505. Upon this request, broker 505 first tries to find the requested element in the cache 520. If the broker 505 cannot find the requested data in the cache, the broker 505 first creates a new element and tries to populate it. Sometimes, the attempted population of the new element does not work, e.g., if the requested element does not exist in the cache 520 or the in the data source 510 itself. If the population attempt is not successful, the existence of the empty element created by the broker 505 will prevent any further attempts to populate the empty element thus saving computing time. Brokers 505 in accordance with the present invention support three search policies: optimistic, pessimistic, and very pessimistic, depending on the nature of elements in the cache. An optimistic search policy is used when there is a high probability that a desired element is going to be found in the cache. The optimistic policy states that the search is first conducted on the open cache 520. If the element is not found in the cache 520, the cache 520 is locked down and the search is conducted again (because some other process might have created the element while the first search was going on). If the element is not found again, it is created and the cache is unlocked. A pessimistic search policy is used when the probability of finding a requested element is low. The pessimistic policy first locks down the cache 520 before the search is conducted A very pessimistic policy is used when the probability of finding an element is virtually nonexistent. In the case of a very pessimistic search, the cache 520 is first locked down and then the empty element is created without searching for it either in the cache 520 or the data source 510. The optimistic policy provides the best throughput and concurrency when elements are mostly in the cache 520. Conversely, in an optimistic search policy, it is very costly when elements are not stored in the cache 520.

Returning to FIG. 3 with the structures of a controller 400 and a broker 500 in mind, the following is a description of how controllers 400 and brokers 500 are employed in system 200. The function of the Position Receiver 320 is to act as the interface between the various controllers and the input stream of position data that requires valuation. Position Receiver 230 is responsible for obtaining positions from input stream adapters 300.305, 310, converting the positions into a map (name-value pairs), and placing the positions onto the input queue of the Position Controller 325. Position Controller 325 thus initiates the process of the position valuation. As further described below Position Controller 325 is also is responsible for placing the position into a cache of Load Collector 355, where the position resides until its valuation is complete.

Position Controller 325 receives in its input queue, messages that contain position information in a raw format. These messages are received from the Position Receiver 325. The function of Position Controller 325 is to construct a position object. It does this by retrieving the asset information from Asset Data database 245 with the help of the Asset Broker 345. A position object comprises a map (set of name-value pairs) of position attributes, references to the asset information in the Asset Broker's cache 345, references to the market data information in the Market Data Broker's cache 350, references to the appropriate valuation models, and probability distributions created as the result of valuation. The position object itself resides inside the Load Collector's cache 355. All controllers (325, 330, 335) operate on references (tokens) to the position object and not on the object itself. Only the references (tokens) are passed between controllers 325,330 and 335. This process of passing tokens as opposed to the objects themselves significantly reduces the overhead related to the distributed nature of the valuation process thus greatly improving the systems response time and throughput.

The Position Controller 325 further constructs valuation adapters from the rules contained in Rules database 250 with the help of the Product Information Broker 340. Valuation adapters are the element primarily responsible for the process of valuation. These valuation adapters connects the position, its prices, its asset, and its valuation method together. The valuation method (model) for the position is contained in system libraries 370 which are referenced by the Rules database 250 on a position by position basis. Each position has its own unique method of valuation which is accomplished by retrieving the appropriate combinations of routines from the system libraries 370. The valuation adapters controls the execution of preparations for the valuation and valuation itself by using valuation method retrieved from system libraries 370. Position Controller 325 constructs market data requests, and populates prices in the position object from the Market Data database 255 with the help of a Market Data Broker 350.

The Product Information Broker 340 has the primary responsibility of producing a correct set of valuation adapters for a position. The Product Information Broker 340 performs this function based on position's instrument and the rules of the business unit holding the position. The model used for valuation of a particular position is dependent on the position's instrument, the business area where the position originated, and hypothetical scenario for which position is valued. For example, the same bond can be valued using duration for one business area, duration and convexity for another business area, and using full valuation if the scenario involves large moves in the yield curve. The Product Information Broker 340 uses a set of rules stored in the metadata in the rules database to analyze characteristics of the position and correctly assign proper valuation model and methodology for the position.

The Asset Broker 345 is responsible for providing asset information to the valuation adapters. The Asset Broker 345 is implemented in the broker pattern as described above with respect to FIG. 5. Asset Broker 345 serves as a repository of valuation related data required during the valuation process. The valuation related data required to perform valuation of a position differs from instrument to instrument. For a bond the valuation data normally consists of coupon, accretion, amortization, and reset schedules, if applicable. For an option the valuation data might be information about the underlying instrument, and so on. These data are used by the valuation model implementation library 370 to produce series of hypothetical profit and losses.

Position Controller 325 is responsible for obtaining market (255) and asset (245) data required for the valuation of the position, performing preliminary valuation, such as computing sensitivities that later on are going to be used for the valuation process, and obtaining from the Product Information Broker (340) nomenclature of risk exposures required for the position, as well as valuation methodologies for each of the risk exposures. Position Controller 325 creates risk exposure objects, associates them with the position, and places each of the risk exposures onto the input queue of the of the Risk Exposure Controller 330 thus initiating the valuation process of the risk exposure. It should be noted that there may be multiple risk exposures associated with a given position. For example, a convertible bond of a foreign corporation has equity, interest, foreign exchange, and credit risk exposures, as well as the full risk exposure. Each risk exposure may require its own valuation methodology and market data.

Risk Exposure Controller 330 obtains a scenario list, according to which the risk exposure is to be valued. The scenario list is a configuration parameter of valuation system 200. Risk Exposure Controller 330 then creates set of hypothetical markets for each scenario, and then evaluates the duration of valuation for each scenario and breaks the scenario set into ranges in order to achieve uniform elapsed valuation time per range. The particular valuation methodology employed depends on the scenario. For example, if a scenario involves large curve moves, full valuation may be required. If a scenario includes only small market moves, valuation using sensitivities may be sufficient. Therefore, valuation times for scenarios in the set are not equal, and the number of scenarios in ranges are different. Risk Exposure Controller is also responsible for assigning the risk exposure to a cell in the multidimensional cube. It analyzes attributes of the risk exposure, and assigns values for each of the coordinates of the cube.

Valuation Range Controller 335 is responsible for valuing a risk exposure according to scenarios contained in the range. As previously described, the data for the valuing the risk exposure contained in the range is passed to the Valuation Range Controller 335 from the Risk Exposure Controller 330. Valuation Range Controller 335 forms the invocation sequence for the appropriate mathematical routine, passing to it hypothetical market data and risk exposure parameters. Valuation Range Controller 335 then obtains the resulting market value and posts it to the vector of profit and losses. When all scenarios in the range have been valued, the controller updates a counter of the required valuations in the position object contained in the Load Collector 355. When all required valuations are completed for the risk exposure, Controller 335 updates a counter of risk exposures (in Collector 355. When all the risk exposures for the position have been valued, Controller 335 marks the position as complete.

Market Data Broker 350 is responsible for maintaining cache of market data. As described above with respect to the generic description of a broker pattern in connection with FIG. 5, if the market data being requested is not found in the cache of the Market Data Broker 350, the Market Data Broker 350 constructs this data by executing a populate member function of the price class, derived from a cacheable element. Price class knows how to retrieve raw market data from the database, and how to construct required curves.

As briefly described above, the primary responsibility of Load Collector 355 is to store positions while their risk exposures are being valued. Load Collector 355 collects positions whose valuations have been completed, batches those positions together for better throughput, and loads the valued positions into the Risk Position database 260. Alternatively, Load Collector 355 sends valued positions into an output stream. Output adapters, such as database adapter 360, serve as output stream helpers. Database Adapter 360 performs formatting functions to assist the Load Collector 355 in loading the Risk Position database 260. Load Collector 355 also performs transaction management and database error management. There may also be other media adapters in addition to Database Adapter 360, such as a network adapter if the stream of valued positions is designated for other media, such as a network, rather than database 260. As described above, the risk position contained in database 260 is an external representation of a cell in the multidimensional cube. A cell contains a set of coordinates, a set of hypothetical market values, and non-statistical attributes that are required in the subsequent risk analysis.

The follow describes, in general, the operation of system 200. System 200 receives about 400 input streams per day. An input stream is either a file from a feeder system, or a XML message from front end applications. These streams contain positions that require valuation. These positions are loaded into the Position database 210 as a batch. Indicative information about the batch is sent to the Valuation engine 200. Upon receiving the batch data, Position Receiver 320 opens the input stream. In case of the database, input stream is a result set of an SQL statement; in case of the network, the input stream is a network connection. Position Receiver 320 transforms the position into the internal form, and sends the position to the Position Controller 325 for valuation. At the same time, Position Receiver 320 sends the position to the Load Collector 355. The position is kept in a cache of Load Collector 355 until the position is fully valued.

Position Controller 325 obtains all market and asset data required for valuation of the position, as well as nomenclature of risk exposures for the position. This data is obtained by Position Controller 325 with the assistance of Asset Data Broker 345 and Market Data Broker 350. Position Controller 325 also identifies what methodologies should be used for valuation of the position with the assistance of Product Information Broker 340. Position Controller 325 then creates risk exposures and sends them to the Risk Exposure Controller 330, one by one.

Risk Exposure Controller 330 identifies scenarios for valuation. The set of scenarios is different from day to day, and from position to position within a day. The set is dependent on market conditions, and is created upon request from the risk management staff. Risk Exposure Controller 330 breaks the set of scenarios into subsets, based on an estimated valuation time and a ratio of valuation time to the dispatching time. Each range of scenarios is sent to Range Controller 335. Range Controller 335 is the element that actually calls the valuation routines contained in system libraries 370. Controller 335 prepares the call parameters from position, market, and asset data. The market data for the position being valued is modified according to the definition of the scenario. At any given moment, there are multiple positions, risk exposures, and scenario ranges are being processed by system 200. When a position has been fully processed (all scenarios for each risk exposure have been valued), it is removed from the Load Collector cache 355, and sent to the output stream. For better throughput, the positions are batched before being sent.

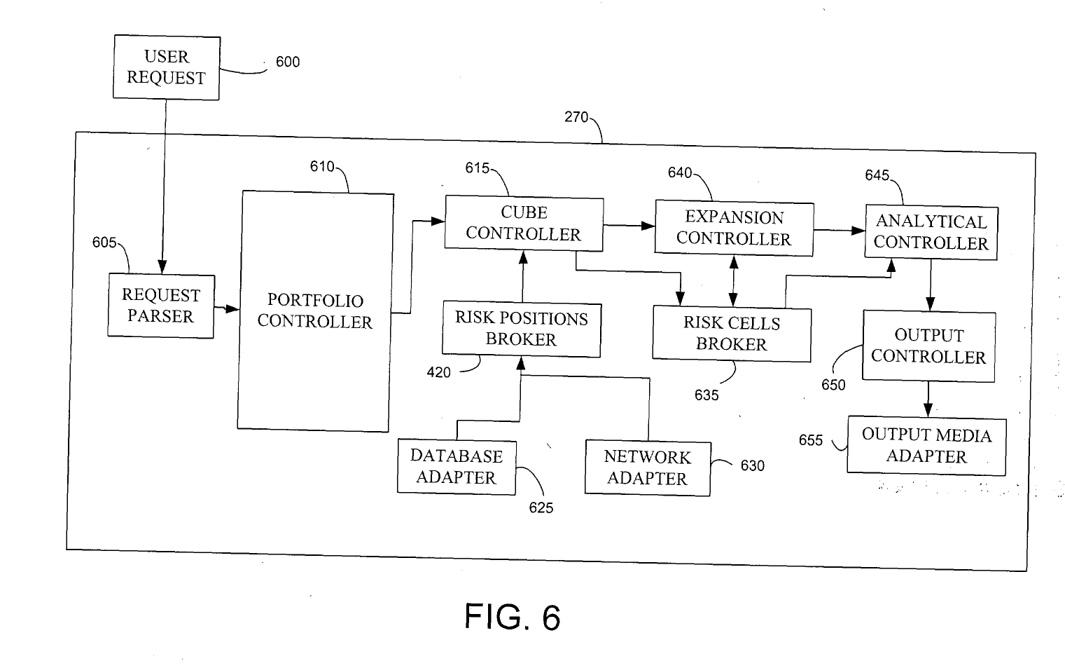

FIG. 6 illustrates the query subsystem 270 of the present invention. Query subsystem 270 builds a multi-dimensional cube based on the contents of the query request 600 submitted by a user, processed by a front-end and passed the a query engine for processing. The organization and contents of the cube is based on the criteria specified in the query request and the data stored in the database 260 or received from Hypothetical database 265 through valuation engine 240 (see FIG. 2).

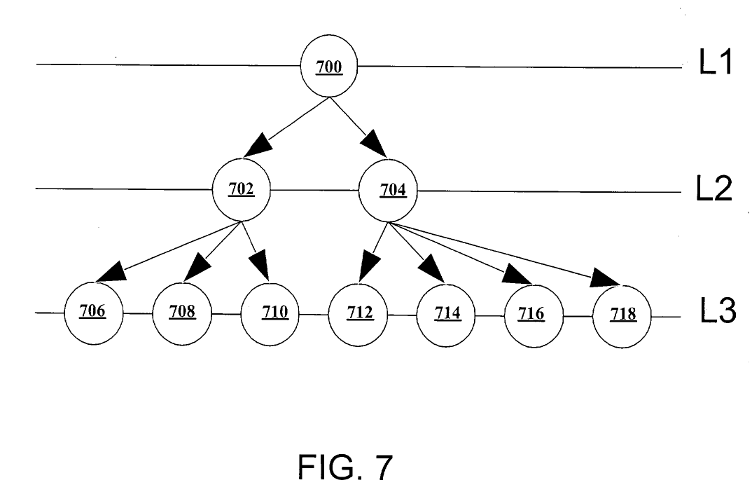

As previously described, Risk Position Database 260 represents a database implementation of the compressed cube. Only leaf level nodes of the hierarchies of the multidimensional cube are stored in database 260. FIG. 7 illustrates a sample hierarchy of the multidimensional cube. In the preferred embodiment, there are 23 dimensions in the cube. Each dimension has multiple hierarchies. Each hierarchy has multiple levels. The circles 700-718 represents nodes of the hierarchy, while horizontal lines L1. L2 and L3 represent levels of the hierarchy. Node 700 is called the root node, nodes 706 through 718 are called leaf nodes. Level L1 is called a root level, and level L3 is called a leaf level.

In the present invention, attributes of the positions, that can be used to select and aggregate data in a query, are the dimensions (in the preferred embodiment, 23 dimensions). Some of the common examples of attributes used in queries are business organization, currency, etc. Query engine 270 uses one or more of these dimensions to classify the positions.

Nodes 700-718 represent the set of allowable values for a dimension. A node ID is a numeric representation of an allowable value for a given dimension. Nodes 700-718 are unique within a dimension (that value can exist only once). However, the same node value may exist in different dimensions (e.g. United States Dollar (USD) has a value X in the currency dimension and Y in the instrument dimension). There is no connection between the two nodes of USD because they belong to two different dimensions). During the loading of a position file, the load process tries to match the value of each attribute to an existing node of the corresponding dimension.

Having attributes of positions classified as nodes 700-718 allows for building correspondence between nodes 700-718 and hence a correspondence between attributes. As illustrated in FIG. 7, query system 270 of the present invention implements hierarchies (trees) of nodes. A hierarchy is specific to a dimension, just as a node is specific to a dimension. Some nodes 700-718 can be created as part of the hierarchy and not directly represent an attribute of a position. (e.g. “North America” could be a node in the currency dimension having children USD and Canadian Dollars (CAD)). In other cases, different positions may map to different levels of a hierarchy. For example, New York/London trading location has two children: New York and London. Some data feeds 215 have feeds in New York or London, and others may sit directly at the New York/London node.

A query 600 (FIG. 6) request to the query engine 270 of the present invention request consists of three basic criterion: Selection Criteria; Display Criteria; and a Set of characteristics. There are also optional criteria that can be specified by the user.

The Selection Criterion specifies what positions from the general universe will comprise the portfolio to be analyzed. The Selection Criterion contains node numbers, and an inclusion and/or exclusion clause. An example Selection Criterion is “INCLUDE:702:704:EXCLUDE:706:714” This sample selection means that all positions containing nodes 702, 704, 708, 710, 712, 716,and 718 must be included in the analyzed portfolio. Specifying a node means specifying all its descendants.

The Display Criterion specifies the dimensionality of the resulting portfolio and the level of the aggregation. A Display Criterion consists of display lines, with the following structure: DIS:<hierarchy name>:<level name>. The number of display lines identifies the dimensionality of the portfolio. Level name identifies the level of aggregation. For example, if level L1 from FIG. 7 is specified, positions referencing nodes 702, 706, 708, and 710 are aggregated and assigned to node 702; positions referencing nodes 704, 712, 714, 716, and 718 are aggregated and assigned to node 704; positions referencing node 700 are aggregated and assigned to special unclassified node.

The Set of Characteristics specifies which statistical characteristics of every aggregated position (called a cell) are to be calculated. The values of the available characteristics are: Mean; VAR at 99% confidence level; VAR at 97% confidence level; VAR at 95% confidence level; VAR at 1 standard deviation; Standard deviation; Marginal VAR at 99% confidence level in respect to the portfolio; Incremental VAR at 99% confidence level in respect to the portfolio; Skeweness; Kurtosis; Outliers; Fatness; Trends at various lookback periods; Idiosyncratic risk; and Default/downgrade risk.

The Query request 600 may specify multiple portfolios to be analyzed. In such a case, the selection criteria for each portfolio may be different, but the display criterion and set of characteristics for each of the portfolios must be the same. The Query subsystem 270 analyses these portfolios and provides pair wise comparison for each of the specified characteristics.

The optional criteria is utilized by a user to specify whether the query request results are to include total cells and/or corresponding information of additional detail data. If the request specifies that no total cells are to be calculated, then certain measures, which depend on calculated totals, will not be available. In a preferred embodiment, this clause is optional. By default, (i.e. if the option clause is not specified) the query results will include calculated totals, but will not include the detail data.

Returning to FIG. 6, the following will describe the elements and operation of system 270. System 270 uses the same controller and broker architecture as described above with respect to valuation engine 240. Request Parser 605 parses the query request 600 and identifies what portfolios need to be constructed and passes each portfolio description to the Portfolio Controller 610. Portfolio Controller 610 builds a selection statement that corresponds to the selection criterion of the portfolio contained in the request 600 and initiates its execution. The resultant streams of risk positions are transformed into risk position objects in adapters 625 or 630, depending on the source of the stream. Risk positions from position database 260 come into the query system 270 though database adaptor 625. Hypothetical risk positions from hypothetical database 265 (though valuation engine 240) come into query system 270 through network adapter 630. Risk position objects from both sources are stored in the Risk Positions Broker 620.

Cube Controller 615 requests risk positions objects from the Risk Positions Broker 620 as they arrive. Cube Controller 615 aggregates the risk positions to the requested aggregation level as described above, and stores the resulting risk cells into Risk Cells Broker 635. After all risk positions are thus processed, Cube Controller 615 passes control to Expansion Controller 640.

Expansion Controller 640 is responsible for building total cells. A total cell is a risk cell that contains aggregation of other risk cells along one or more dimensions. For example, let the portfolio be a two-dimensional cube with the following risk cells:

(n1,n3), (n1,n4), (n2,n3), and (n2,n4).

Then it has 5 total cells as follows:

(t,n3) contains aggregate of (n1,n3) and (n2,n3)

(t,n4) contains aggregate of (n1,n4) and (n2,n4)

(n1,t) contains aggregate of (n1,n3) and (n1,n4)

(n2,t) contains aggregate of (n2,n3) and (n2,n4)

(t,t) contains aggregate of all 4 risk cells.

After the Expansion Controller 640 builds all total cells, it passes control to the Analytical Controller 645. Analytical Controller 645 is responsible for calculating the requested characteristics for each of the risk and total cells, using probability distribution of each cell, and passes it to the Output Controller 650. Output Controller 650 uses the Output Media Adapter 655 to serialize out the cell object according to the requirements of the respective media, such as database, flat file, Excel, XML.

Although the present invention has been described in relation to particular embodiments thereof, many other variations and other uses will be apparent to those skilled in the art. It is preferred, therefore, that the present invention be limited not by the specific disclosure herein, but only by the gist and scope of the disclosure.

We claim:

1. A system for performing risk analysis of a portfolio of positions, the system comprising:
an input interface adapter, the input interface adapter receiving position data describing at least some of the positions in the portfolio;
at least one controller coupled to the input interface adapter, the controller performing a valuation of the position data, the controller comprising:
an input queue,
a controller manager coupled to the input queue, and
a plurality of workers coupled to the controller manager, wherein the number of workers coupled to the controller manager is scalable;
at least one data broker coupled to the at least one controller, wherein the data broker provides the controller with data required for performing the valuation.

2. The system of claim 1, further comprising:
a position database coupled to the input interface adapter, the position database storing the position data.

3. The system of claim 1, further comprising:
a hypothetical position interface coupled to the input interface adapter, the hypothetical position interface providing hypothetical position data.

4. The system of claim 1, further comprising:
a network coupled to the input interface adapter, the network providing the position data to the input interface adapter.

5. The system of claim 1, further comprising:
a position receiver coupled to the input interface adapter, the position receiver converting the position data into a map of name-value pairs.

6. The system of claim 1, wherein the at least one controller further comprises:
a position controller, the position controller constructing a position object, the position object including references to asset information, market data information and valuation models.

7. The system of claim 6, further comprising:
an asset data broker coupled to the position controller, the asset data broker providing the position controller with the references to the asset information, the asset information describing static data related to assets.

8. The system of claim 7, further comprising:
an asset database coupled to the asset data broker, the asset database storing the asset information.

9. The system of claim 6, further comprising:
a market data broker coupled to the position controller, the market data broker providing the position controller with the references to the market data information, the market data information describing variable market data related to positions.

10. The system of claim 9, further comprising:
a market data database coupled to the market data broker, the market data database storing the market data information.

11. The system of claim 6, further comprising:
a product information broker coupled to the position controller, the product information broker providing the position controller with the valuation models, the valuation models describing models by which positions are valued.

12. The system of claim 11, further comprising:
a rules database coupled to the product information broker, the rules database storing rules governing the valuation models.

13. The system of claim 6, further comprising:
a risk exposure controller coupled to the position controller, the risk exposure controller receiving the position object from the position controller and creating at least one risk exposure and hypothetical market data for at least one scenario with respect to the at least one risk exposure.

14. The system of claim 13, further comprising:
a valuation range controller coupled to the risk exposure controller, the valuation range controller valuing the at least one scenario associated with the position object.

15. The system of claim 1, further comprising a plurality of controllers performing the valuation of positions.

16. The system of claim 15, further comprising:
a load collector coupled to the plurality of controllers, the load collector storing position objects representing the positions, wherein tokens referencing the position objects are passed between the plurality of controllers and not the position objects themselves.

17. The system of claim 16, further comprising:
a risk position database coupled to the load collector, the risk position database storing valued risk position data.

18. The system of claim 1, wherein the at least one data broker comprises:
a broker manager, the broker manager managing requests for data;
a data source adapter coupled to the broker manager, the data source adapter interfacing with sources of data; and
a cache coupled to the broker manager, the cache storing data retrieved from the data source.

19. The system of claim 1, wherein the at least one data broker employs one of a plurality of data searching methodologies including an optimistic search, a pessimistic search and a very pessimistic search.

20. A method for performing risk analysis of a portfolio of positions, the method comprising:
receiving position data describing at least some of the positions in the portfolio;
valuing the position data by a controller, the controller having a plurality of workers;
automatically scaling a number of workers in the controller in regard to the volume of position data; and
retrieving valuation data required by the controller in order to perform the valuation.

21. The method of claim 20, further comprising storing the position data in a position database.

22. The method of claim 20, further comprising receiving hypothetical position data.

23. The method of claim 20, further comprising receiving the position data from a network.

24. The method of claim 20, further comprising converting the position data into a map of name-value pairs.

25. The method of claim 20, further comprising constructing a position object, the position object including references to asset information, market data information and valuation models.

26. The method of claim 25, further comprising providing the controller with the references to the asset information, the asset information describing static data related to assets.

27. The method of claim 26, further comprising storing the asset information in an asset database.

28. The method of claim 25, further comprising:
providing the controller with the references to the market data information, the market data information describing variable market data related to positions.

29. The method of claim 28, further comprising storing the market data information in a market data database.

30. The method of claim 25, further comprising providing the controller with the valuation models, the valuation models describing models by which positions are valued.

31. The method of claim 30, further comprising storing rules governing the valuation models in a rules database.

32. The method of claim 25, further comprising creating at least one risk exposure and hypothetical market data for at least one scenario with respect to the at least one risk exposure.

33. The method of claim 32, further comprising valuing the at least one scenario associated with the at least one risk exposure.

34. The method of claim 20, wherein a plurality of controllers are involved in the valuation of positions.

35. The method of claim 34, further comprising:
storing position objects representing the positions in a load collector; and
passing tokens referencing the position objects between the plurality of controllers and not passing the position objects themselves.

36. The method of claim 35, further comprising storing valued risk position data.

37. A system for performing risk analysis of a portfolio of positions, the system comprising:
a position controller, the position controller constructing a position object for each position received by the position controller;
a risk exposure controller coupled to the position controller, the risk exposure controller receiving the position object from the position controller and creating at least one risk exposure and hypothetical market data for at least one scenario with respect to the at least one risk exposure; and
a valuation range controller coupled to the risk exposure controller, the valuation range controller valuing the at least one scenario associated with the at least one risk exposure.

38. A query system for use in a risk analysis system containing a portfolio of positions, the query system comprising:
a portfolio controller receiving a query from a user, the portfolio controller determining risk positions required to satisfy the query;
a cube controller coupled to the portfolio controller, the cube controller receiving and aggregating the risk positions;
an expansion controller coupled to the cube controller, the expansion controller building a multidimensional cube of cells from the aggregated risk positions; and
an analytical controller coupled to the expansion controller, the analytical controller calculating characteristics contained in the query using the multidimensional cube of cells.

39. The query system of claim 38 wherein the cells in the multidimensional cube contain distributions of random variables.
